(19) United States
(12) Patent Application Publication
(10) Pub. No.: US 2019/0205749 A1
(43) Pub. Date: Jul. 4, 2019

(54) OPTIMIZING WIRELESS NETWORKS BY PREDICTING APPLICATION PERFORMANCE WITH SEPARATE NEURAL NETWORK MODELS

(71) Applicant: Cisco Technology, Inc., San Jose, CA (US)

(72) Inventors: Wai-tian Tan, Sunnyvale, CA (US); Robert Edward Liston, Menlo Park, CA (US); Xiaoqing Zhu, Austin, TX (US); Mehdi Nikkhah, Belmont, CA (US)

(21) Appl. No.: 15/860,307

(22) Filed: Jan. 2, 2018

(51) Int. Cl. G06N 3/08; G06N 7/00

(52) U.S. Cl. CPC G06N 3/08; G06N 7/005

(57) ABSTRACT

A network device that is configured to optimize network performance collects a training dataset representing one or more network device states. The network device trains a first model with the training dataset. The first model may be trained to generate one or more fabricated attributes of artificial network traffic through the network device. The network device trains a second model with the training dataset. The second model may be trained to generate a predictive experience metric that represents a predicted performance of an application program of a client device communicating traffic via the network. The network device generates the fabricated attributes based on the training of the first model. The network device generates the predictive experience metric based on the training of the second model and using the one or more fabricated attributes. The network device alters configurations of the network based on the predictive experience metric.

### TECHNICAL FIELD

The present disclosure relates to wireless networks.

### BACKGROUND

Accurate characterization of application performance over wireless networks is a key component to optimizing wireless network operations. The characterization of application performance allows for the detection of problems that matter to end users of the wireless network, as well as confirmation that those problems are addressed once the wireless network has been optimized. While network traffic throughput is an acceptable indicator of application performance for many application types, network traffic throughput is insufficient for interactive applications, such as video conferencing, where loss, delay, and jitter typically have a greater negative affect on the performance of the interactive applications. Therefore, in order to more accurately optimize wireless networks, it is desirable to determine application performance from the observable network states, which are available in access points, without generating probing traffic that requires additional infrastructure during run time, or without tracking live traffic from a specific application.

### BRIEF DESCRIPTION OF THE DRAWINGS

FIG. 1 is a block diagram of a wireless network environment configured to optimize wireless network performance, according to an example embodiment.

FIG. 2 is a block diagram of a neural network processing system disposed within a network device of the wireless network environment of FIG. 1, according to an example embodiment.

FIG. 3 is a block diagram of an architecture of a network generative model illustrated in FIG. 2, according to an example embodiment.

FIG. 4 is a flowchart of a method for training the network generative model illustrated in FIG. 2, where the network generative model is configured to generate fabricated attributes of artificial network traffic communicated through a network device.

FIG. 5 is a flowchart of a method for training the application model illustrated in FIG. 2, where the application model is configured to generate a predictive experience metric of an application program of a client device of the wireless network environment of FIG. 1.

FIG. 6 is a block diagram of an access point of the wireless network environment, illustrated in FIG. 1, the access point being equipped with the neural network processing system of FIG. 2 and configured to perform the techniques described herein.

FIG. 7 is a block diagram of the server of the wireless network environment, illustrated in FIG. 1, the server being equipped with the neural network processing system of FIG. 2 and configured to perform the techniques described herein.

FIG. 8 is a flowchart of a method of optimizing a network based on fabricated attributes of artificial network traffic and a generated predictive experience metric, according to an example embodiment.

### DESCRIPTION OF EXAMPLE EMBODIMENTS

### Overview

Techniques presented herein relate to optimizing network performance based on performance of an application program running on a client device that communicates traffic through a network device, even when the application program is not actively communicating traffic through the network device. The network device may collect a training dataset representing one or more states of the network device deployed in a network. The network device may train a first model disposed within the network device with the training dataset. The first model may be trained to generate one or more fabricated attributes of artificial network traffic through the network device. The network device may also train a second model disposed within the network device with the training dataset. The second model may be trained to generate a predictive experience metric that represents a predicted performance of an application program of a client device that is connected to the network device and is communicating traffic via the network device. The network device may then generate the one or more fabricated attributes based on the training of the first model. Furthermore, the network device may generate the predictive experience metric based on the training of the second model and using the one or more fabricated attributes. Using the predictive experience metric, the network device may alter one or more configurations of the network based on the predictive experience metric.

### Example Embodiments

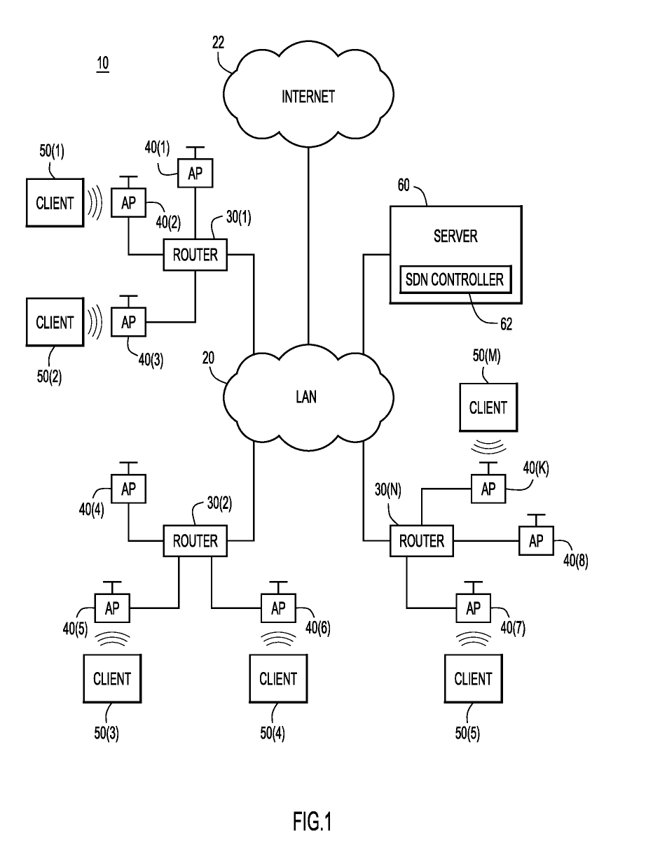

Reference is first made to FIG. 1. FIG. 1 shows a network environment 10 that supports a wireless network capability, such as a Wi-Fi® wireless local area network (WLAN). The network environment 10 includes multiple network routers 30(1)-30(N) that are connected to the wired local area network (LAN) 20. The LAN 20 may connected to the Internet shown at reference numeral 22. Furthermore, each router 30(1)-30(N) is connected to any number of wireless access points (APs) 40(1)-40(K). While FIG. 1 illustrates three APs being connected to each router 30(1)-30(N), any number of APs may be connected to each router 30(1)-30(N) of the environment. As illustrated, the APs 40(1)-40(K) support WLAN connectivity for multiple wireless client devices (also called “clients” herein), which are shown as reference numerals 50(1)-50(M). It should be understood that FIG. 1 is only a simplified example of network environment 10. There may be any number of client devices 50(1)-50(M) in a real network deployment. Moreover, for some applications, there may be only a single AP in a deployment.

The network environment 10 further includes a central server 60. More specifically, the APs 40(1)-40(K) connect to LAN 20 via the routers 30(1)-30(N), and the server 60 is connected to the LAN 20. The server 60 may include a software defined networking (SDN) controller 62 that enables the server 60 to control functions for the APs 40(1)-40(K) and the clients 50(1)-50(M) that are connected to network 20 via the APs 40(1)-40(K). The SDN controller 62 of the server 60 may, among other things, enable the server 60 to perform location functions to track the locations of clients 50(1)-50(M) based on data gathered from signals received at one or more APs 40(1)-40(K). Furthermore, the server 60 may be a physical device or apparatus, or may be a process running in the cloud/datacenter.

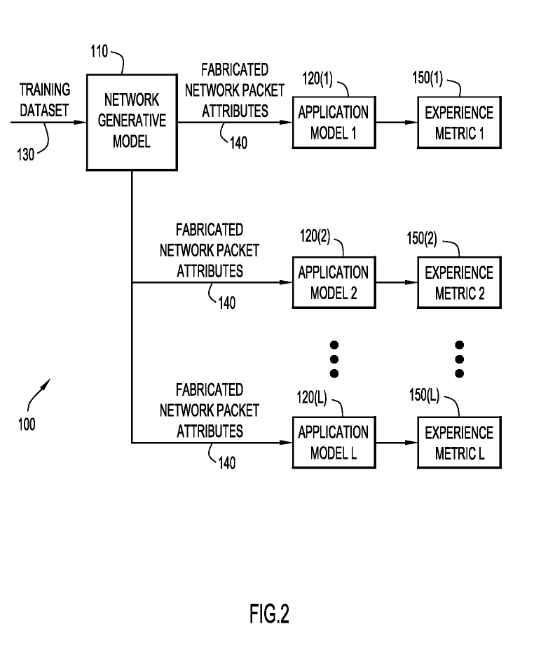

With reference to FIG. 2, illustrated is neural network processing system 100 that is configured to predict application performance of a client device application program in order to optimize WLAN performance. As illustrated in FIG. 2, the system 100 may include a network generative model 110 and one or more application models 120(1)-120(L). The system 100 may be deployed in any number of the APs 40(1)-40(K) in the network environment 10 shown in

FIG. 1, or, conversely, may be deployed in the server 60 shown in FIG. 1. When the system 100 is deployed in the server 60, the system 100 may include more than one network generative model 110, one for each one of the APs 40(1)-40(K) of the network environment 10. The system 100 may be configured to observe or collect various network states (e.g., real attributes of actual traffic or network packets) of a network device (e.g., routers 30(1)-30(N), APs 40(1)-40(K) as a training dataset 130 for use by the network generative model 110 and/or the application models 120(1)-120(L). More specifically, the system 100 may observe or collect characteristics or attributes (e.g., loss per packet, delay per packet, etc.) of actual network packets that travel through a network device in order to formulate the training dataset 130. After observing and collecting real attributes of actual network packets for a period of time, the training dataset 130 is utilized by the network generative model 110 to perform machine learning to generate one or more fabricated network packet attributes 140 for a set of artificial traffic that mimics attributes of actual traffic processed by the observed network device. The term “fabricated” is used to indicate that the attributes are not for real/actual network traffic observed in the network environment. Likewise, the term “artificial” is meant to indicate that the network traffic is not real/actual network traffic but is instead artificially created network traffic that is representative or mimics actual network traffic passing through a network device.

As further illustrated in FIG. 2, the network generative model 110 may send the fabricated network packet attributes 140 to one or more of the application models 120(1)-120(L). Each application model 120(1)-120(L), as further detailed below, may be a classical neural network model. Each application model 120(1)-120(L) may be modeled after a specific application program running on a client device 50(1)-50(M) that is capable of connecting to an AP. With each application model 120(1)-120(L) being modeled on a specific application program, each application model 120(1)-120(L) is configured to generate a predictive experience metric 150(1)-150(L) that is unique for its respective application program. Moreover, the generated predictive experience metrics 150(1)-150(L) are generated based on a given set of network packet attributes that serve as inputs for the application models 120(1)-120(L). Each of the application models 120(1)-120(L) may be capable of generating a predictive experience metric 150(1)-150(L) regardless of whether the application models 120(1)-120(L) receive real network packet attributes or fabricated network packet attributes. The generated predictive experience metrics 150(1)-150(L) represent a calculated metric of a predicted performance of a respective application program when given a set of network packet attribute inputs. In some embodiments, the predictive experience metric is either an expected Mean Opinion Score (MOS) that reflects sound quality, or a probability distribution of the MOS given an observed network state. Thus, for example, application model 120(1) may be modeled to generate a predictive experience metric 150(1) of the performance of a WebEx® online conferencing application program given a set of network packet attributes. Similarly, application model 120(2) may be modeled to generate a predictive experience metric 150(2) of the performance of the video application program Skype® given the same set of network packet attributes. Examples of other application programs for which the techniques presented herein may be used include, but are not limited to, the messaging and online conferencing application Jabber®, the online collaboration program Spark®, the video telephony application FaceTime®, etc.

It is known that network devices may utilize a single model to generate a predictive experience metric in order to optimize a network, where the single model models together the interactions of the network device and the applications. To do so, the network devices contain a single model to represent each network device type and specific application program combination. As the number increases for both the types of network devices (e.g., different types of APs) and the different application programs, the number of single network models greatly increases. Furthermore, when a new network device is introduced, or when the software of an application program changes (e.g., an update is issued for the application program), the entire model would need to be retrained. This can result in a significant amount of downtime for generating predictive experience metrics. However, the architecture of the system 100 described above with reference to FIG. 2, where the system 100 includes a network generative model 110 separate from one or more application models 120(1)-120(L), enables an improved functionality over single network models. For example, when a new AP is introduced into the network environment 10, only a new network generative model needs to be trained, and, once trained, the new network generative model 110 can be utilized with the one or more existing application models 120(1)-120(L). In addition, the system 100 contains multiple application models 120(1)-120(L) that are modeled to represent different application programs, when a software change is issued for one of the application programs (e.g., the application program is updated, etc.), only the respective application model needs to be retrained.

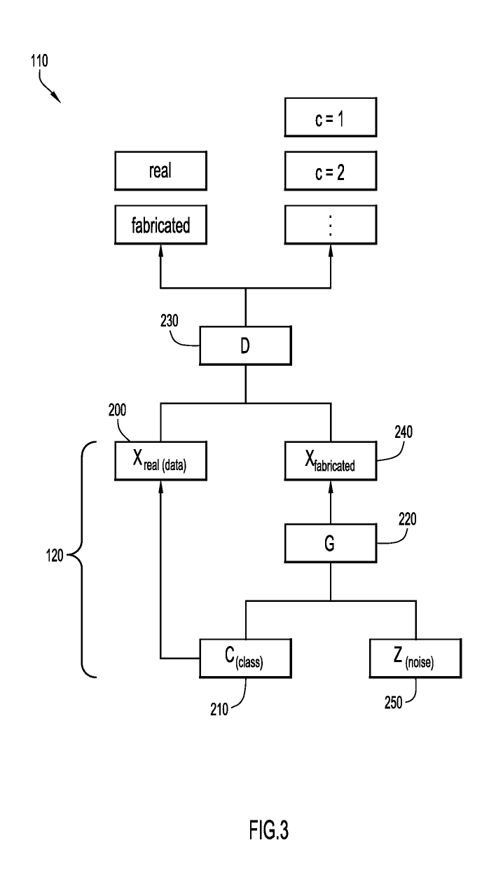

Turning to FIG. 3, and with continued reference to FIGS. 1 and 2, illustrated is one embodiment of the architecture of network generative model 110 where the network generative model 110 is an auxiliary classifier generative adversarial network (AC-GAN) model. While FIG. 3 depicts the architecture of one type of generative adversarial network (GAN) model, the network generative model 110 may be any type of GAN model. As previously explained, the network generative model 110 is configured to observe or collect network states over a predefined period of time to serve as a training dataset 130. In some embodiments, this period of time may be approximately 10 seconds, but, for other embodiments, the period of time may be greater or less than 10 seconds. The training dataset 130 may be collected as a series of data points in the form of (X_{real(data)}, C_{class}), where X_{real(data)} 200 is a representation of the real attributes of a network packet flowing through the observed network device during a window of time, and C_{class} 210 is a discrete representation of the network device state during that same window of time. X_{real(data)} 200 includes, but is not limited to, loss and delay of each packet that travels through the network device. Additionally, C_{class} 210 includes, but it not limited to, dynamic states of the network device such as radio frequency (RF) utilization, central processing unit (CPU) load, queue depths, and client count. Cu_{class} 210 further includes static configurations, such as, but not limited to, quality of service settings. The training dataset 130 is used by the network generative model 110 to train or machine learn to generate fabricated attributes of artificial network packets that mimic that of the attributes of actual network packets of the training dataset 130.

As further illustrated in FIG. 3, the network generative model 110 includes a generator model 220 and a discriminator model 230. The generator model 220 is configured or trained to generate fabricated network packet attributes for a series of artificial network packets, while the discriminator model 230 is configured or trained to identify the fabricated network packet attributes of the artificial network packets from the network packet attributes of the actual network packets. In other words, the network generative model 110 is a GAN model where the generator model 220 and the discriminator model 230 are trained in opposition of one another, such that the generator model 220 is configured to deceive the discriminator model 230, and the discriminator model 230 is configured to determine which analyzed network packet attributes are generated by the generator model 230. The generator model 220 may use the formula:

X_{fabricated}=G(C, Zₙₒᵢₛₑ),

where X_{fabricated} 240 is the fabricated network packet attributes of a network packet, C is a training dataset of conditional classes that may include fabricated conditional classes C_{fabricated} and the conditional classes C_{dass} 210 of the training dataset 130, and Zₙₒᵢₛₑ 250 is a noise variable. The parameters of the generator model 220 are updated so that the output of the X_{fabricated} 240 attributes (given Znₙₒᵢₛₑ 250 as a random input) of the generator model 220 cannot be distinguished from actual network packet attributes X_{real(data)} by the discriminator model 230. Moreover, the determination of Zₙₒᵢₛₑ 250 may be determined independent of the data of the training dataset 130.

The discriminator model 230 is configured to analyze network packet attributes for a series of network packets and provide a probability distribution of an identified source S for each set of network packet attributes, as well as a probability distribution of the class condition C. Thus, discriminator model 230 may use the formula:

P(S|X), P(C|X)=D(X),

where P is the probability assigned by the discriminator model 230, S is the source of the analyzed network packet attributes, and X is a dataset that includes both X_{fabricated} and X_{real(data)}. More specifically, the discriminator 230 may be trained to maximize the log-likelihood that it assigns the correct source and class to the analyzed packet attributes as follows:

L_{S}=E[log P(S=real|X_{real(data))}+E[log P(S=fabricated|X_{fabricated}),

L_{C}=E[log P(C=C_{class}|X_{real(data))}+E[log P(C=C_{fabricated}|X_{fabricated}),

where L_{S} is the log-likelihood of the correct source, and L_{C} is the log-likelihood of the correct conditional class. The discriminator model 230 is trained to maximize the value of L_{S}+L_{C}, while the generator model 220 is trained to maximize the value of the value of L_{C}−L_{S}. This architecture of the AC-GAN network generative model 110 permits the network generative model to separate large datasets of network traffic into subsets by conditional class, and then train the generator model 220 and the discriminator model 230 for each of the conditional class sub sets.

While the embodiment of the network generative model 110 illustrated in FIG. 3 is depicted as a GAN model with a generator model 220 and a discriminator model 230 trained in opposition of one another, in other embodiments, the network generative model 110 may be a database. When the network generative model 110 is a database, the network generative model 110 is fed the training data 130, which is stored within the database. In some example embodiments, the database may store a large number of network packet attributes and network device states (i.e., in the thousands). When the network generative model 110 is a database, the network generative model 110 may then reproduce the fabricated network packet attributes 140 that are exact copies of the data within the training dataset 130 that is stored in the database.

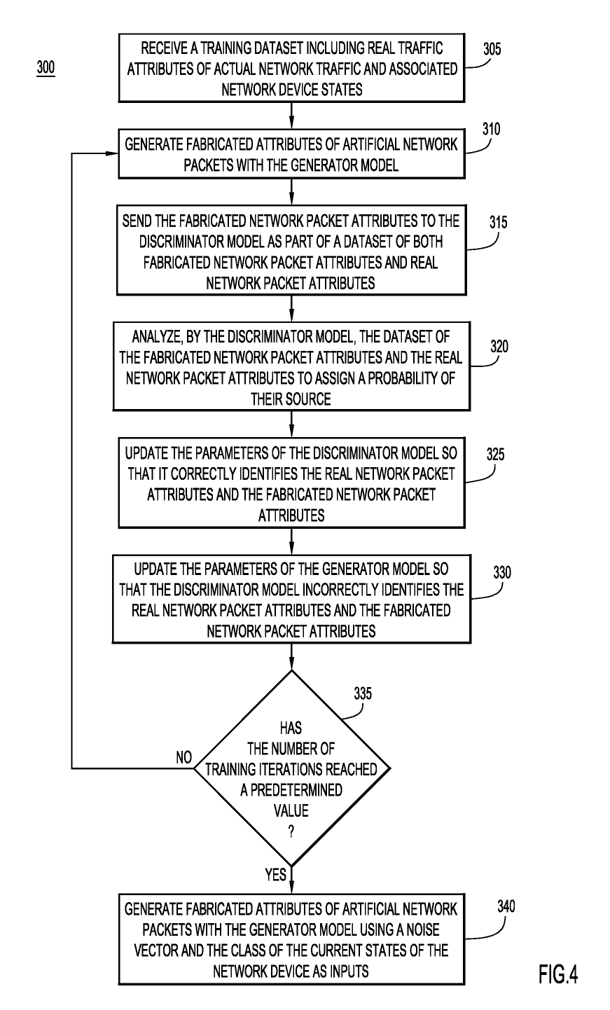

With reference to FIG. 4, and continued reference to FIGS. 1-3, there is depicted a flowchart of a method 300 for training a network generative model 110 having the architecture illustrated in FIG. 3. Initially, at 305, the network generative model 110 receives a training dataset 130. As previously explained, the training dataset 130 may be a set of data representing the real attributes of the actual network packets observed and/or collected by the network device in which the network generative model 110 is trained to represent. Furthermore, the training dataset 130 may include, among other types of data, real attributes (e.g., per packet loss, per packet delay, etc.) of actual network packets and the state of the network device during the observation window of time. At 310, the generator model 220 may generate a training set of fabricated network packet attributes 240 of artificial network packets based on a fabricated conditional class C_{fabricated} and a randomly selected noise value 250, as previously explained. As explained below, this training set of fabricated network packet attributes 240 may be utilized to train both the generator model 220 and the discriminator model 230. Once the initial set of fabricated network packet attributes 240 have been generated by the generator model 220, at 315, the generator model 220 sends the fabricated attributes 240 to the discriminator model 230. Prior to the discriminator model 230 receiving the training fabricated attributes 240, the training fabricated attributes 240 may be stored as part of a dataset that includes both the training fabricated network packet attributes 240 generated by the generator model 220 and the real network packet attributes 200 observed and collected by the network device.

At 320, the discriminator model 230 analyzes the data set of network packets attributes, and assigns to each analyzed network packet attribute a probability that the analyzed network packet attribute is a real attribute of an actual network packet or is a fabricated attribute of an artificial network packet. In other words, at 320, the discriminator model 230 determines whether an analyzed network packet attribute was observed and/or collected by the network device or was generated by the generator model 220. At 325, after analyzing the dataset of both real and fabricated network packet attributes 200, 240, the discriminator model 230 is trained so that it more correctly identifies which network packet attributes are from the training dataset 130 and which network packet attributes were fabricated from the by the generator model 220. In other words, the parameters of the discriminator model 230 are updated so that the discriminator model 230 accurately identifies the source and class (‘Rear’, C_{class}) when fed (X_{real(data))}, and accurately identifies the source and class (‘Fabricated’, C_{fabricated}) when fed (X_{fabricated}). Furthermore, at 330, the generator model 220 is trained so that it generates fabricated network packet attributes 240 that the discriminator model 230 cannot accurately identify as being fabricated by the generator model 220. In other words, the parameters of the generator model 220 are updated so that the discriminator model 230 incorrectly identifies the source and class (‘Real’, C_{fabricated}) when fed (X_{fabricated}). The completion of steps 310-330 may constitute one training iteration of the generator and discriminator models 220, 230. At 335, it is determined whether or not a predetermined number of training iterations has been run by the network generator model 110. If at 335, the number of training iterations that have been run is less than the predetermined value, then the method 300 returns to 310, where the generator model 220 generates a new training set of fabricated network packet attributes 240 based on a fabricated conditional class C_{fabricated} and a randomly selected noise value 250 as inputs. However, if, at 335, the number of training iterations that have been run equals the predetermined value, then, at 340, generator model 220 generates a set of fabricated network packets 140 to send to an application model 120(1)-120(L), as illustrated in FIG. 2. In this instance, the fabricated network packet attributes 140 are based on a current conditional class of the network device and a randomly selected noise value 250. Once the generator model 220 is trained, the generator model 220 can produce sets of fabricated network packet attributes 140 for the application models 120(1)-12(L) using only the randomly selected noise vector 250 and the current conditional class or state of the network device.

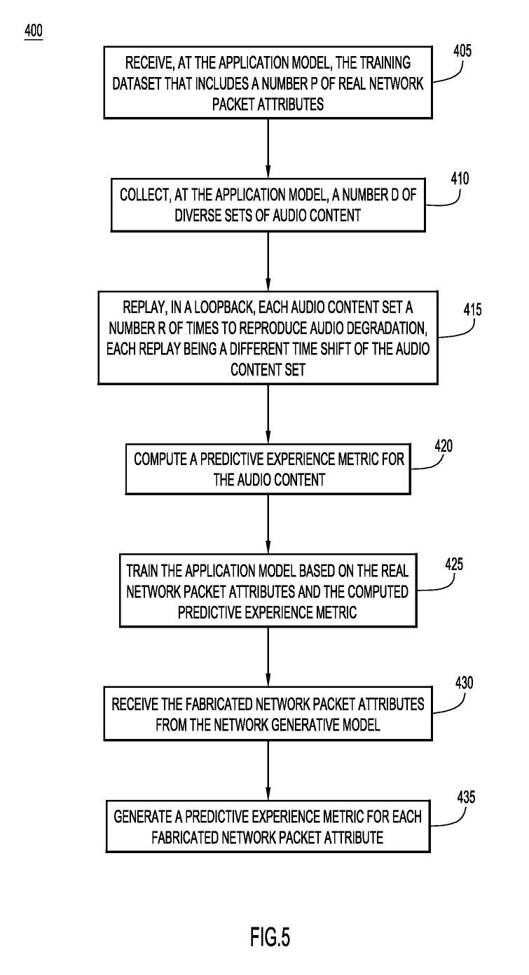

With reference to FIG. 5, and continued reference to FIGS. 1-4, there is depicted a flowchart of a method 400 for training an application model 120 and generating a predictive experience metric with the application model 120 using the fabricated network packet attributes 240 as the inputs for the predictive experience metric. As previously explained, the application model 120 may be modeled after a specific application program capable of running on a client device 50, where that specific application program utilizes network traffic from the AP 40 in which the client device 50 is connected. Initially, at 405, the application model 120 receives the training dataset 130 that was observed and collected by the network device. The training dataset 130 contains a number P of the real network packets and the associated attributes of each network packet. The attributes include, but are not limited to, network packet delay and network packet loss. In one embodiment, the number P may be a large number, such as five thousand (5000) real network packets. In other embodiments, a number of real network packets may be collected as part of the training dataset 130. At 410, the application model collects a number D of diverse sets of audio content. In one example embodiment, the number D of diverse sets of audio content is eighty (80). However, in other embodiments, a number of diverse sets of audio content may be collected. At 415, the application model 120 replays, in a loopback, each audio content set based on the attributes of each one of the network packets of the training dataset 130. The replay of each audio content set is further based on how the respective application program would play the same audio content set given the attributes of the network packets. For example, the same audio content may be played differently by a WebEx® application program than by a Spark® collaboration application program, even when the network data received by each of these programs is the same. The application model 120 replays each audio content set for a number R of different time shifts of the audio content set. In one example embodiment, the application model 120 may replay each audio content set ten (10) times at different time shifts of the audio content set.

At 420, after the application model 120 has finished replaying each of the audio content sets for each one of the network packet attributes of the training dataset 130, the application model 120 calculates a predictive experience metric 150 that is associated with each set of attributes of each of the network packets of the training dataset 130. Thus, each network packet attribute set is associated with a distribution of predictive experience metrics 150, one predictive experience metric 150 for each replay of an audio content set. For example, if the training dataset 130 includes attributes sets for each of the 5000 network packets, if the application model 120 collects 80 different sets of audio content, and if each audio content set is replayed 10 times, then each of the 5000 network packet attribute sets contains a distribution of 800 (80 audio content sets×10 replays) predictive experience metrics 150. As previously explained, this predictive experience metric 150 may be an expected MOS value, or a probability distribution over likely MOS values. The MOS may be computed by the application model 120 using standard waveform-based methods, such as, but not limited to, the Perceptual Evaluation of Speech Quality (PESO) method, the Perceptual Evaluation of Audio Quality (PEAR) method, the Perceptual Objective Listening Quality Analysis (POLQA) method, etc.

Once the predictive experience metrics 150 are calculated, at 425, the application model 120 is trained based on the predictive experience metrics distributions 150 and each of the network packet attribute sets of the training dataset 130. In other words, the application model 120 is trained to associate a given network packet attribute set with a predictive experience metric distribution 150. At 430, the application model 120 receives the fabricated network attribute sets 240 from the network generative model 110. At 435, the application model 120, based on the training of the application model 120, generates a predictive experience metric distribution 150 for each of the received fabricated network attribute sets 240. Steps 405 through 425 may occur simultaneously to that of the method 300 illustrated in FIG. 3, or may occur after the method 300 has been completed. Steps 430 and 435 of method 400, however, occur after the method 300 has been completed.

While the embodiment of the application models 120(1)-120(L) illustrated in FIGS. 2 and 5 are depicted as application models that are trained to predict the performance of an audio application program based on network traffic, in other embodiments, the application models 120(1)-120(L) may also be used to predict the performances of a variety of other application programs, such as video application programs, slide sharing application programs, etc. For example, if an application model 120(1) is modeled to generate a predictive experience metric 150(1) of the performance of a video application program, the predictive experience metric 150 may differ from the MOS value/probability distribution of MOS values described above. In this example, the application model 120(1) may generate a predicted experience metric 150(1) as an expected Peak Signal to Noise Ratio (PSNR) value, a probability distribution over likely PSNR values, an expected Structural SIMilarity Index (SSIM) value, a probability distribution over likely SSIM values, etc.

Once the application model 120 generates the predictive experience metric distribution 150, the system 100 may alter one or more configurations of the network environment 10 to better optimize the network environment 10. In one embodiment, where the client devices 50(1)-50(M) are mobile wireless devices having multiple modes of connectivity, such as, but not limited to, WiFi® and broadband cellular network connectivity (4G, 5G, etc.), the system 100 may be configured to recommend to each one of the client devices 50(1)-50(M) connected to an AP 40(1)-40(K) the optimal type of network connection when operating an associated application program. The server 60 or serving AP for the given client device may send this recommendation to the given client device prior to the given client device operating the associated application program.

In yet a similar embodiment, where the system 100 resides in the server 60, the server 60 will continuously monitor the operation states of the APs 40(1)-40(K), and compute predictive experience metrics 150 for application programs communicating data through each APs 40(1)-40(K). The server 60 can then store the predictive experience metrics 150 (e.g., in software defined networking (SDN) controllers 62) so that when an application is operated on a client device (e.g., initiating a conference call using WebEx or Spark), the server 60 can consult the SDN controller 62 for the corresponding one of the APs 40(1)-40(K) and their associated predictive experience metrics 150. If a specific AP has a poor predictive experience metric 150, the SDN controller 62 will notify/control that specific AP or the relevant clients associated to that specific AP, so that the client devices associated with that specific AP will be instead utilize broadband cellular network connectivity.

In yet another embodiment, the system 100 may be utilized to instruct a client device to connect to a specific one of the APs 40(1)-40(K) of the network environment 10. Conventionally, AP selections are initiated by the client devices 50(1)-50(M) based on signal strength, etc. To assist the client devices 50(1)-50(M) to make informed decisions, extensions such as IEEE 802.11k allow for providing a suggested list of APs 40(1)-40(K) to a client device. When equipped with the ability to generate predictive experience metrics 150, either from the APs 40(1)-40(K) or from the central server 60, the server 20 or APs can continuously update/modify/sort the suggested list of APs so that a given client device can be directed to a particular one of the APs 40(1)-40(K) that can best sustain/support the network traffic needed for an application program running on the given client device.

Furthermore, in another embodiment, because the techniques and the system 100 presented above enable the prediction of application-specific experience metrics 150, the system 100 may provide the client devices 50(1)-50(M) (i.e., directly to the application controller via programmable application programming interfaces (APIs)) with a recommended application mode (e.g., audio-only versus voice and video for a conferencing application) based on current network conditions of the network 20 and the APs 40(1)-40(K). For example, the system 100 may direct the application of a client device 50(1)-50(M) that is attempting to establish a video conference from a public venue during a heightened network traffic time to initiate the video conference with audio-only.

In a further embodiment, the system 100 may be trained to generate predictive experience metrics 150 for applications, where the predictive experience metrics 150 are conditioned on different network configurations (e.g., treating the traffic flow as prioritized classes). Consequently, this information can be used to guide the server 60 or APs 40(1)-40(K) to dynamically and automatically adjust the quality of service (QoS) configurations to best maximize the expected performance of all network traffic flows sharing the same AP 40(1)-40(K).

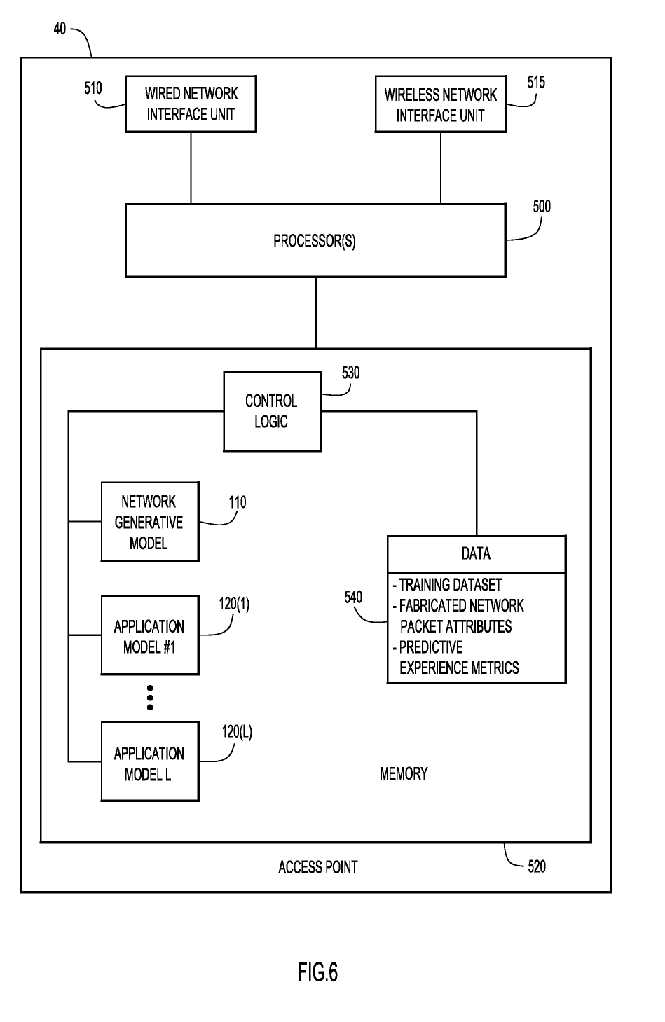

Reference is now made to FIG. 6, which shows an example block diagram of an AP generically identified by reference numeral 40 of the network environment 10, where the AP 40 is equipped with the neural network processing system 100 that is configured to perform the techniques for optimizing the configurations of the network environment 10 according to the embodiments described herein. There are numerous possible configurations for AP 40, and FIG. 6 is meant to be an example. AP 40 includes a processor 500, a wired network interface unit 510, a wireless network interface unit 515 and memory 520. The wired network interface unit 520 is, for example, an Ethernet card or other interface device that allows the AP 40 to communicate over network 20. The wireless network interface unit is, for example, a WiFi® chipset that includes RF, baseband and control components to wirelessly communicate with client devices 50(1)-50(M).

The processor(s) 500 may be embodied by one or more microprocessors or microcontrollers, and execute software instructions stored in memory 520 for the control logic 530, the network generative model 110, and the application models 120(1)-120(L) in accordance with the techniques presented herein in connection with FIGS. 1-5.

The memory 520 may include read only memory (ROM), random access memory (RAM), magnetic disk storage media devices, optical storage media devices, flash memory devices, electrical, optical, or other physical/tangible (e.g., non-transitory) memory storage devices. Thus, in general, the memory 520 may comprise one or more computer readable storage media (e.g., a memory device) encoded with software comprising computer executable instructions and when the software is executed (by the processor 500) it is operable to perform the operations described herein. For example, the memory 520 stores or is encoded with instructions for control logic 530 for managing the operations of the network generative model 110 of the AP 40 and the multiple application models 120(1)-120(L).

In addition, memory 520 stores data 540 that is observed and collected by the AP 40, and is generated by logic/models 530, 110, 120(1)-120(L), including, but not limited to: the training dataset 130 of real network packet attributes (i.e., packet loss, packet delay, etc.) and class/operational state of the AP 40; fabricated network packet attributes (i.e., packet loss, packet delay, etc.) generated by the network generative model 110; and predictive experience metrics (i.e., MOS distributions) generated by the application models 120(1)-120(L).

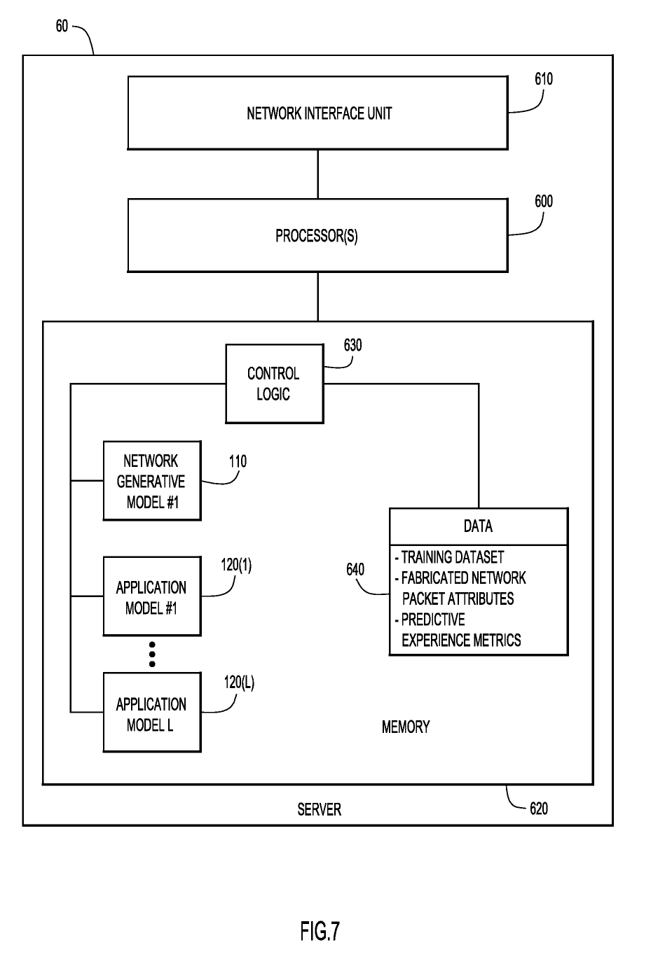

Illustrated in FIG. 7 is an example block diagram of the server 60 of the network environment 10, where the server 60 is equipped with the neural network processing system 100 that is configured to perform the techniques for optimizing the configurations of the network environment 10 in accordance with the embodiments described herein. As shown, the server 60 includes one or more processor(s) 600, a network interface unit 610, and memory 620. The network interface 610 is, for example, an Ethernet card or other interface device that allows the server 60 to communicate over network 20 (as illustrated in FIG. 1).

The processor(s) 600 may be embodied by one or more microprocessors or microcontrollers, and execute software instructions stored in memory 620 for the control logic 630, one or multiple network generative models 110, and the application models 120(1)-120(L) in accordance with the techniques presented herein in connection with FIGS. 1-5.

Memory 620 may include one or more computer readable storage media that may comprise read only memory (ROM), random access memory (RAM), magnetic disk storage media devices, optical storage media devices, flash memory devices, electrical, optical, or other physical/tangible memory storage devices.

Thus, in general, the memory 620 may include one or more tangible (e.g., non-transitory) computer readable storage media (e.g., a memory device) encoded with software comprising computer executable instructions, and when the software is executed by the processor(s) 600, the processor(s) 600 are operable to perform the operations described herein by executing instructions associated with the control logic 630 for managing the operations of the one or more network generative models 110 representative of each of the APs 40(1)-40(K), and of the multiple application models 120(1)-120(L).

In addition, memory 620 stores data 640 that is observed and collected by the various APs 40(1)-40(K), and is generated by logic/models 630, 110, 120(1)-120(L), including, but not limited to: the training dataset 130 of real network packet attributes (i.e., packet loss, packet delay, etc.) and class/operational states of the APs 40(1)-40(K); fabricated network packet attributes (i.e., packet loss, packet delay, etc.) 240 generated by the one or more network generative models 110; and predictive experience metrics (i.e., MOS distributions) 150 generated by the application models 120(1)-120(L).

The functions of the processor(s) 600 may be implemented by logic encoded in one or more tangible computer readable storage media or devices (e.g., storage devices compact discs, digital video discs, flash memory drives, etc. and embedded logic such as an ASIC, digital signal processor instructions, software that is executed by a processor, etc.).

While FIG. 7 shows that the server 60 may be embodied as a dedicated physical device, it should be understand that the functions of the server 60 may be embodied as software running in a data center/cloud computing system, together with numerous other software applications.

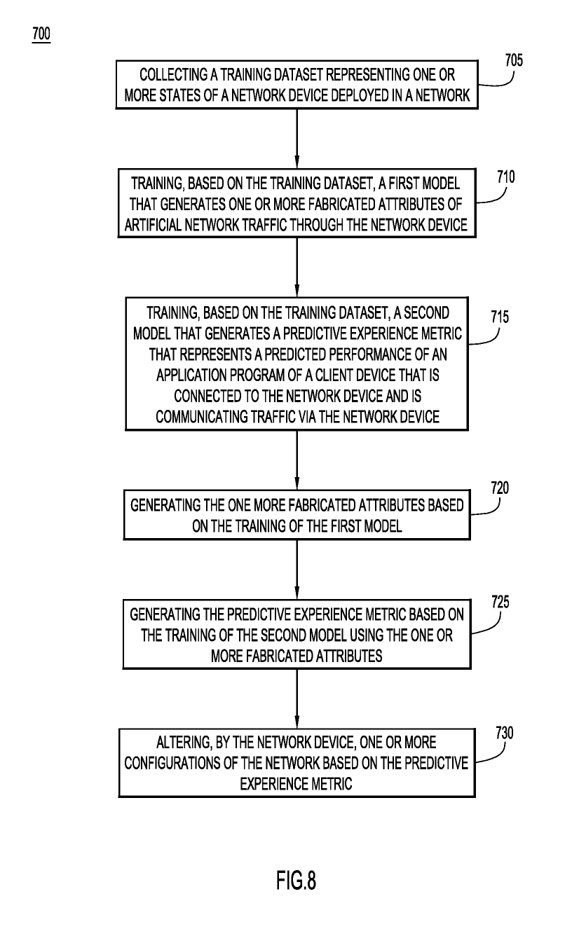

With reference to FIG. 8, illustrated is a flow chart of a method 700 for optimizing a network based on the predicted performance of an application program communicating data over the network. Reference is also made to FIGS. 1-7 for purposes of the description of FIG. 8. At 705, a training dataset is collected. As previously explained, the training dataset may include one or more actual operational states of a network device being observed, as well as the network traffic that travels through the network device. The network device may include, but is not limited to, routers 30(1)-30(N) and APs 40(1)-40(K), of the network environment 10 as shown in

FIG. 1. At 710, a first neural network model (i.e., the network generative model) is trained using the training dataset. The first model is trained to generate one or more sets of fabricated attributes of artificial network packets. At 715, a second neural network model (i.e., an application program model) is trained using the training dataset. The second model is trained to generate a predictive experience metric that represents a predicted performance of an application program of a client device of the network environment. At 720, the first model generates the one or more fabricated attributes based on the training of the first model. The generated one or more fabricated attributes are then supplied to the second model, where, at 725, the second model generates the predictive experience metric based on the training of the second model and using the fabricated attributes. At 730, the network device alters the configurations of the network based on the generated predictive experience metric.

In summary, the method and system described above enable wireless networks to be optimized based on separate neural network models that generated sets of fabricated attributes of artificial network packets and predictive experience metrics of application programs. The method and system described above further enable wireless networks to be optimized even when the application programs are not actively communication data over the wireless network. This allows wireless networks to be optimized prior to use by an application program, which maximizes application performance and minimizes any time periods where the network may negatively affect application performance. Furthermore, the system described above provides an accurate predictive experience metric of application programs because the application models are based on actual application specific strategies of concealment, loss-recovery, de-jittering, etc., and because the predictive experience metrics capture variations of application content. In addition, because the predictive experience metrics are calculated and generated using a neural network, the computational cost per generated predictive experience metric is greatly reduced compared to that of conventional experience metrics that require actual operation of the application program and/or network traffic. Moreover, the system and method described above enable the continuous optimization of a wireless network because it requires minimal amounts of data collection. Once the two neural network models have been trained (i.e., the network generative model and an application model), the models may be continuously utilized to generate predictive experience metrics that are used to optimize wireless network performance. Even if a model is required to be retrained, the data collection time for acquiring a new training dataset may be as little as ten seconds, while the predictive experience metric may be calculated offline or without running any application programs.

The separate model system described above, also provides advantages over a single model system. As previously explained, the network generative model may be used for multiple application programs, and for different versions of the same application program (i.e., when the application program is updated). This results in a reduced amount of down-time for retraining of the models when the application programs are altered or updated. Furthermore, the application models may be used for different network generative models. For example, if each AP of the network environment is represented by a network generative model, and additional APs are added to the network environment, the existing application models may be utilized with the new network generative models of the new APs. This prevents the need for retraining of each of the applications models when changes occur to the network devices that are represented by the network generative models.

In one form, a method is provided comprising: collecting, at a network device, a training dataset representing one or more states of the network device deployed in a network; training, by the network device and based on the training dataset, a first model that generates one or more fabricated attributes of artificial network traffic through the network device; training, by the network device and based on the training dataset, a second model that generates a predictive experience metric that represents a predicted performance of an application program of a client device that is connected to the network device and is communicating traffic via the network device; generating the one more fabricated attributes based on the training of the first model; generating the predictive experience metric based on the training of the second model using the one or more fabricated attributes; and altering, by the network device, one or more configurations of the network based on the predictive experience metric.

In another form, an apparatus is provided comprising: a network interface unit configured to enable communications over a network; and a processor coupled to the network interface unit, the processor configured to: collect a training dataset representing one or more states of a network device deployed in a network; train, based on the training dataset, a first model that generates one or more fabricated attributes of artificial network traffic through the network device; train, based on the training dataset, a second model that generates a predictive experience metric that represents a predicted performance of an application program of a client device that is connected to the network device and is communicating traffic via the network device; generate the one more fabricated attributes based on the training of the first model; generate the predictive experience metric based on the training of the second model using the one or more fabricated attributes; and alter one or more configurations of the network based on the predictive experience metric.

In yet another form, a (non-transitory) processor readable storage media is provided. The computer readable storage media is encoded with software comprising computer executable instructions, and when the software is executed, operable to: collect a training dataset representing one or more states of a network device deployed in a network; train, based on the training dataset, a first model that generates one or more fabricated attributes of artificial network traffic through the network device; train, based on the training dataset, a second model that generates a predictive experience metric that represents a predicted performance of an application program of a client device that is connected to the network device and is communicating traffic via the network device; generate the one more fabricated attributes based on the training of the first model; generate the predictive experience metric based on the training of the second model using the one or more fabricated attributes; and alter one or more configurations of the network based on the predictive experience metric.

The above description is intended by way of example only. Various modifications and structural changes may be made therein without departing from the scope of the concepts described herein and within the scope and range of equivalents of the claims.

What is claimed is:

1. A method comprising:
collecting, at a network device, a training dataset representing one or more states of the network device deployed in a network;
training, by the network device and based on the training dataset, a first model that generates one or more fabricated attributes of artificial network traffic through the network device;
training, by the network device and based on the training dataset, a second model that generates a predictive experience metric that represents a predicted performance of an application program of a client device that is connected to the network device and is communicating traffic via the network device;
generating the one more fabricated attributes based on the training of the first model;
generating the predictive experience metric based on the training of the second model using the one or more fabricated attributes; and
altering, by the network device, one or more configurations of the network based on the predictive experience metric.

2. The method of claim 1, wherein the training dataset includes at least one of the following:
attributes of actual network traffic experienced by the network device; and
a conditional class that represents an operational state of the network device.

3. The method of claim 2, wherein the first model is an auxiliary classifier generative adversarial network model that includes a generator model and a discriminator model.

4. The method of claim 3, wherein the generator model is trained to generate the one or more fabricated attributes based on a conditional class of the network device and a random noise value.

5. The method of claim 3, wherein the discriminator is trained to differentiate between the one or more fabricated attributes generated by the generator model and the attributes of the training dataset.

6. The method of claim 1, wherein altering one or more configurations of the network further comprises:
causing, by the network device, a network controller to alter one or more configurations of the network to improve performance of traffic flows passing through the network device.

7. The method of claim 1, wherein altering one or more configurations of the network further comprises:
causing, by the network device, the client device to alter connectivity of the client device to the network device.

8. The method of claim 1, wherein altering one or more configurations of the network further comprises:
providing, by the network device, the client device with a recommended application mode for the application program of the client device.

9. The method of claim 1, wherein the first model is a database.

10. An apparatus comprising:
a network interface unit that enables communication over a network; and
a processor coupled to the network interface unit, the processor configured to:
collect a training dataset representing one or more states of a network device deployed in a network;
train, based on the training dataset, a first model that generates one or more fabricated attributes of artificial network traffic through the network device;
train, based on the training dataset, a second model that generates a predictive experience metric that represents a predicted performance of an application program of a client device that is connected to the network device and is communicating traffic via the network device;
generate the one more fabricated attributes based on the training of the first model;
generate the predictive experience metric based on the training of the second model using the one or more fabricated attributes; and
alter one or more configurations of the network based on the predictive experience metric.

11. The apparatus of claim 10, wherein the training dataset includes at least one of the following:
attributes of actual network traffic experienced by the network device; and
a conditional class that represents an operational state of the network device.

12. The apparatus of claim 11, wherein the first model is an auxiliary classifier generative adversarial network model that includes a generator model and a discriminator model.

13. The apparatus of claim 12, wherein the generator model is trained to generate the one or more fabricated attributes based on a conditional class of the network device and a random noise value.

14. The apparatus of claim 12, wherein the discriminator is trained to differentiate between the one or more fabricated attributes generated by the generator model and the attributes of the training dataset.

15. The apparatus of claim 10, wherein the processor, when altering one or more configurations of the network, is further configured to:
cause a network controller to alter one or more configurations of the network to improve performance of traffic flows passing through the network device.

16. The apparatus of claim 10, wherein the processor, when altering one or more configurations of the network, is further configured to:
cause the client device to alter connectivity of the client device to the network device.

17. One or more non-transitory computer readable storage media, the computer readable storage media being encoded with software comprising computer executable instructions, and when the software is executed, operable to:
collect a training dataset representing one or more states of a network device deployed in a network;
train, based on the training dataset, a first model that generates one or more fabricated attributes of artificial network traffic through the network device;
train, based on the training dataset, a second model that generates a predictive experience metric that represents a predicted performance of an application program of a client device that is connected to the network device and is communicating traffic via the network device;
generate the one more fabricated attributes based on the training of the first model;
generate the predictive experience metric based on the training of the second model using the one or more fabricated attributes; and
alter one or more configurations of the network based on the predictive experience metric.

18. The non-transitory computer readable storage media of claim 17, wherein the training dataset includes at least one of the following:
attributes of actual network traffic experienced by the network device; and
a conditional class that represents an operational state of the network device.

19. The non-transitory computer readable storage media of claim 18, wherein the first model is an auxiliary classifier generative adversarial network model that includes a generator model and a discriminator model.

20. The non-transitory computer readable storage media of claim 19, wherein the generator model is trained to generate the one or more fabricated attributes based on a conditional class of the network device and a random noise value, and wherein the discriminator is trained to differentiate between the one or more fabricated attributes generated by the generator model and the attributes of the training dataset.
